(19) United States
(12) Patent Application Publication
(10) Pub. No.: US 2026/0168513 A1
(43) Pub. Date: Jun. 18, 2026

(54) Fan Wheel and Fan

(71) Applicant: MAHLE International GmbH, Stuttgart (DE)

(72) Inventors: Florian Mayot, Tiefenau (FR); Herbert Hofmann, Kornwestheim (DE); Matteo Wenner, Stuttgart (DE)

(21) Appl. No.: 19/420,460

(22) Filed: Dec. 15, 2025

(30) Foreign Application Priority Data
Dec. 17, 2024 (DE) 102024138293.7

(51) Int. Cl. F04D 29/38; B60H 1/00; B60L 1/00; F04D 19/00; F04D 29/32

(52) U.S. Cl. CPC F04D 29/384; B60H 1/00392; B60H 1/00464; F04D 19/002; F04D 29/325; B60L 1/003

(57) ABSTRACT

A fan wheel for a fan that has at least two blades is provided. Each of the blades, has a wavelike or serrated shaping with projections and recesses on the front edge.

Substantial to the invention is that the ratio of the height (A) of the projections to the wavelength (W) from one trough to the next is defined as follows

$$A / W \geq 1 .$$

### CROSS-REFERENCE TO RELATED APPLICATIONS

This application claims priority from German Patent Application No. DE 102024138293.7, filed on Dec. 17, 2024, the entirety of which is hereby incorporated by reference herein.

The present invention relates to a fan wheel for a fan that has at least two blades, according to the preamble of Numbered Paragraph 1. The invention also relates to a fan, specifically for an air conditioner in an electric vehicle, that has such a fan wheel.

U.S. Pat. No. 11,035,233 B2 discloses such a fan wheel for a fan that has at least two blades, the front edges of which have a wavelike or serrated shape comprising projections and recesses.

Another fan wheel of this type is disclosed in WO 2013/180296 A1.

Fans are used for a number of things in battery electric vehicles (BEVs), with particular attention being given to efficiency and the noise generated by these fans. Particularly with electric vehicles, efficiency has a direct impact on the amount of electricity consumed by the fan's motor, and therefore on the travel range of the vehicle. In addition, the noise generated by these fans is of particular importance, because these vehicles are much quieter that those powered by internal combustion engines. Fans are used in electric vehicles for the thermal management modules that control the temperature of the batteries. It is important to keep these batteries cool, because operating the battery within an optimal temperature window not only increases the travel range, but also reduces charging times.

There are already fan wheels in the prior art that have blades with wavelike or serrated front or back edges, resulting in a particularly effective means of reducing noise.

The disadvantage with these fan wheels is that the sizes of shapes used in the prior art, i.e. the wavelike or serrated front or back edges, are not ideal, and do not significantly increase the efficiency of these blades, and therefore the fan itself, while substantially increasing the noise they generate.

The problem addressed by the present invention is to therefore create a better, or at least different, design for this type of fan wheel, with which the disadvantages of the prior art can be resolved.

This problem is solved with the invention by the subject matter of independent Numbered Paragraph 1. Advantageous embodiments are the subject matter of the dependent Numbered Paragraphs.

The present invention is based on the general idea of designing projections and recesses in a wavelike or serrated front edge of the blades that have a height A and wavelength W that significantly increases the efficiency without significantly increasing the noise generated by the blades. This is achieved by a ratio of the height A of the projections to the wavelengths W measured from one recess to the next, i.e. from one trough to the next, that is defined as follows: A/W≥1. This results in both a more efficient, as well as a quieter operation of the fan equipped with such a fan wheel. A further increase in the efficiency of the fan, without increasing the noise it generates, can be achieved if the ratio of the height A of the projections to the wavelength W from one trough to the next is A/W≥1.5, preferably A/W≥2. The upper limit is usually set at ca. 4. Anything higher than this results in projections that are too flexible. The design for a fan wheel obtained with the invention can therefore significantly increase the efficiency of the fan, without increasing the noise it generates.

The height A can also be at least 10% of the width BL of the blade that the air passes over, and is preferably at least 15% thereof, ideally 20%. The width BL that the air passes over can be selected specifically for the blade.

The shaped edge is ideally only ca. 70%, preferably only ca. 50% of the radial length of the blade, beginning at the inner end, near the hub, and ending at ca. 70% of its length, and thus not extending over the entire radial length of the blade. Tests have shown that the effects obtained with this shaping of the edge with regard to increasing efficiency and reducing noise are limited to specific rotational speeds, such that at the outer ends of the blades, where they are moving faster, this shaping is not advantageous.

This shaping starts at the hub or at a distance thereto in advantageous designs of the fan wheel obtained with the invention. There are advantages with both versions regarding production thereof, in particular if the fan wheel is an injection molded part.

Ideally, at least one projection is tilted in the circumferential direction in relation to the blade. The main advantage with this is that the tip of the projection points in the direction in which the blade rotates, and is not at an angle thereto.

In a particularly preferred design of the fan wheel obtained with the invention, at least one of the projections is thicker than the rest of the blade. This projection can transition smoothly to the rest of the blade, such that it has aerodynamic advantages, and notch stresses caused by kinks or folds can be prevented.

In a particularly preferred design of the blade obtained with the invention, the projections are made of a different material than the blade. They may be made of metal, for example, while the blade is made of plastic, resulting in a two-component injection molded part. If the projections are made of metal, the A/W ratio can be increased, without having to worry about them becoming bent when the fan is in use.

The back edge of the blades can also have this wavelike or serrated shape. This can also increase the efficiency and reduce the noise generated by these blades. The shaping of the back edge can be identical to that of the front.

By connecting adjacent projections, the strength of the projections can be further increased, resulting in a particularly stiff and quiet fan wheel.

The present invention is also based on the idea of equipping a fan with the fan wheel described above, such that the advantages described above for the fan wheel also apply to the fan. Specifically, these advantages are a more efficient and quieter fan. This fan can be used in electric vehicles, which are extremely quiet. The increase in efficiency results in lower power consumption by the fan, which is also advantageous when used in electric vehicles.

Important features and advantages of the invention can be derived from the dependent Numbered Paragraphs, drawings, and descriptions of the drawings.

It is understood that the features specified above and explained below can be used not only in the given combinations, but also in other combinations, or in and of themselves, without abandoning the scope of protection for the invention. Components of a higher order unit specified above or below, e.g. an element, device, or assembly, that are indicated separately, may form separate components of this unit, or integral parts thereof, even if otherwise indicated in the drawings.

Preferred exemplary embodiments of the invention are shown in the drawings and shall be explained in greater detail below, in which the same reference symbols are used for the same, similar, or functionally identical components.

Therein, schematically:

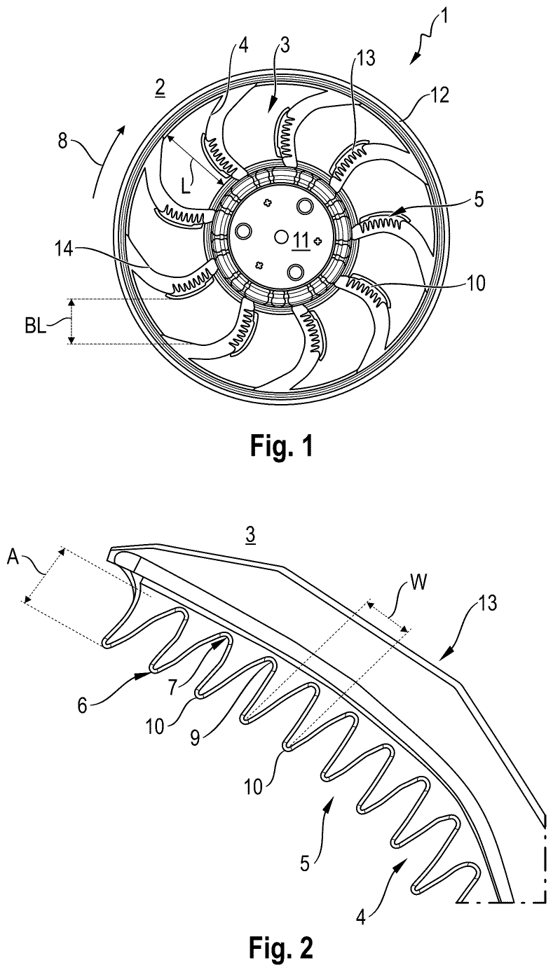

FIG. 1 shows a fan wheel obtained with the invention for a fan obtained with the invention; and

FIG. 2 shows a detail of FIG. 1.

FIG. 1 shows a fan wheel 1 obtained with the invention in a fan 2 obtained with the invention, e.g. for an electric vehicle (not shown), which has at least two blades 3 (see FIG. 2), each of which have a wavelike or serrated shaping 5 on the front edge 4, which comprises projections 6 and recesses 7. The front edge 4 refers to the direction 8 in which the fan wheel rotates.

The fan wheel 1 in FIG. 1 has nine blades 3, although it could also have fewer or more such blades 3.

The ratio of the height A (see FIG. 2) of the projections 6 to the wavelength W, measured from one trough 9 to the next, or from one peak 10 to the next (see FIG. 2), is defined as follows:

$$A / W \geq 1 .$$

As a result of the comparatively slender and tall projections, the fan wheel 1 is not only more efficient, it is also comparatively quieter when the fan wheel 1 is spinning, which is a major advantage with very quiet electric vehicles.

The heights A of the projections 6 can differ of the length of the shaping 5.

To be able to further increase the efficiency without significantly increasing the noise, the height A to wavelength W ratio, i.e. from one trough 9 to the next, or from one peak 10 to the next, can also be ≥1.5, or ≥2.0.

The peaks 10 of the projections 6 are rounded, as indicated in FIG. 2. These peaks 10 could also be pointed or angular.

The height A of the projections 6 is at least 10% of the width BL of the blades (see FIG. 1), preferably at least 15% of the width BL, more preferably at least 20% of the width BL of the blades that the air passes over. The ratio of the height A of the projections 6 to the width BL of the blades 3 over which air passes can further effect the efficiency as well as the noisiness of the fan wheel 1.

FIG. 1 also shows that the shaping 5 only extends over ca. 70% of the radial length L of the blades 3. This shaping 5 is on the inner part of the blade, where it spins more slowly when the fan 2 is operating. This shaping can also extend over only 50% of the radial length L of the blade.

The blades 3 extend from a hub 11 to an outer ring 12, and are formed integrally with the hub 11 and the ring 12. The shaping can be at a distance to the hub 11, or it can begin directly at the hub 11.

FIGS. 1 and 2 also show that the projections 6 are tilted in the circumferential direction, i.e. in the direction of rotation, in relation to the blades 3, making them more aerodynamic.

At least one projection 6 can be thicker that the rest of the blade 3, and can then transition smoothly to the blade 3, such that it is more aerodynamic, resulting in a reduction in notch stresses.

Because of the delicate design of the projections 6, and the forces generated when the fan wheel 1 is spinning, the projections can be made of a different material than the blades 3, i.e. the blade 3 can be made of plastic, and the projections 6 can be made of metal. The projections 6 and the recesses 7 can be part of an inlay 13 made of metal, which is then connected to the plastic blade 3. This connection can be obtained in an injection molding tool, thus forming a two-component injection molded part. This not only simplifies production, but also results in a stronger inlay 13, as well as a reliable and sturdy connection to the plastic blade 3. In general, the entire fan wheel 1, aside from the inlay 13, can be a single plastic injection molded part, although it is also conceivable to form the projections 6 as an integral part of the blades 3, to obtain a single plastic injection molded part comprising the blades 3, hub 11, and ring 12. In this case, the entire fan wheel 1 is made of the same plastic material. Purely theoretically, the entire fan wheel 1 could also be made of metal.

The shaping 5 is on the front edge 4 of the blade, although it is also conceivable to form such a shaping 5 on the back edge 14 as well. This further increases the efficiency of the fan wheel 1, without making it noisier.

Two adjacent projections 6 can also be connected to one another, in particular by a connection not shown in the drawings that is above the plane of the blade 3.

The fan wheel 1 and fan 2 obtained with the invention are significantly more efficient, without being noisier, which is a major advantage when used in quiet vehicles, particularly electric vehicles. Moreover, this fan wheel 1 can be produced easily and inexpensively.

The specification can be readily understood with reference to the following Numbered Paragraphs:
Numbered Paragraph 1. A fan wheel (1) for a fan (2) that has at least two blades (3), each of which has a wavelike or serrated shaping (5) with projections (6) and recesses (7) on the front edge (4), characterized in that the ratio of the height A of the projections (6) to the wavelength W, measured from one trough (9) to the next, is defined as follows

$$A / W \geq 1 .$$

Numbered Paragraph 2. The fan wheel (1) according to Numbered Paragraph 1, characterized in that the ratio is defined as follows

$$A / W \geq 1 \text{.5} , in particular A / W \geq 2. .$$

Numbered Paragraph 3. The fan wheel (1) according to Numbered Paragraph 1 or 2, characterized in that the projections (6) are rounded and/or angled peaks (10), or serrations.
Numbered Paragraph 4. The fan wheel (1) according to any of the preceding Numbered Paragraphs, characterized in that the height A is at least 10% of the width BL, preferably at least 15% of the width BL, more preferably at least 20% of the width BL, of the blade (3) that air passes over.
Numbered Paragraph 5. The fan wheel (1) according to any of the preceding Numbered Paragraphs, characterized in that the shaping (5) only extends over ca. 70%, preferably only ca. 50% of the radial length L of the fan wheel (3).
Numbered Paragraph 6. The fan wheel (1) according to any of the preceding Numbered Paragraphs, characterized in that the shaping (5) starts at a hub (11), or starts at a distance to the hub (11).
Numbered Paragraph 7. The fan wheel (1) according to any of the preceding Numbered Paragraphs, characterized in that at least one projection (6) is tilted in the circumferential direction in relation to the blade (3).
Numbered Paragraph 8. The fan wheel (1) according to any of the preceding Numbered Paragraphs, characterized in that at least one projection (6) is thicker than the rest of the blade (3).
Numbered Paragraph 9. The fan wheel (1) according to any of the preceding Numbered Paragraphs, characterized in that the at least one thicker projection (6) transitions smoothly to the blade (3).
Numbered Paragraph 10. The fan wheel (1) according to any of the preceding Numbered Paragraphs, characterized in that the projections (6) are made of a different material than the blades (3).
Numbered Paragraph 11. The fan wheel (1) according to any of the preceding Numbered Paragraphs, characterized in that the blades (3) and projections (6) form a two-component injection molded part.
Numbered Paragraph 12. The fan wheel (1) according to any of the preceding Numbered Paragraphs, characterized in that the blades (3) also have a wavelike or serrated shaping (5) with projections (6) and recesses (7) on their back edges.
Numbered Paragraph 13. A fan (2), in particular for an air conditioner in an electric vehicle, which has a fan wheel (1) according to any of the preceding Numbered Paragraphs.

### LIST OF REFERENCE SYMBOLS

1 fan wheel
2 fan
3 blade
4 front edge of the blade
5 shaping
6 projection
7 recess
8 direction of rotation
9 trough
10 peak
11 hub
12 ring
13 inlay
14 back edge of the blade

1-13. (canceled)

14. A fan wheel for a fan, comprising at least two blades, each of which has a wavelike or serrated shaping with one or more projections and one or more recesses disposed upon the front edge, wherein a ratio of a height (A) of the one or more projections to a wavelength (W), measured from one trough to the next, is defined as follows
$$A / W \geq 1 .$$

15. The fan wheel according to claim 14, wherein the ratio is defined as follows
$$A / W \geq 1 \text{.5} .$$

16. The fan wheel according to claim 14, wherein the one or more projections are rounded and/or have angled peaks, or are serrations.

17. The fan wheel according to claim 14, wherein the height of each blade A is at least 10% of a width of each blade that air passes over (BL).

18. The fan wheel according to claim 14, wherein the shaping only extends over approximately 70% of a radial length (L) of the fan wheel.

19. The fan wheel according to claim 14, wherein the shaping starts at a hub, or starts at a distance to the hub.

20. The fan wheel according to claim 14, wherein at least one projection of the one or more projections is tilted in a circumferential direction in relation to the blade.

21. The fan wheel according to claim 14, wherein at least one projection of the one or more projections is thicker than a remaining portion of the blade.

22. The fan wheel according to claim 21, wherein the at least one thicker projection transitions smoothly to the blade.

23. The fan wheel according to claim 14, wherein the one or more projections are made of a different material than the blades.

24. The fan wheel according to claim 14, wherein the blades the respective at least one projection disposed upon each blade form a two-component injection molded part.

25. The fan wheel according to claim 14, wherein the blades further comprise a wavelike or serrated shaping with at least one projections and at least one recess upon a back edge of the respective blade.

26. A fan, in particular for an air conditioner in an electric vehicle, which has a fan wheel according to claim 14.

27. The fan wheel according to claim 15, wherein the ratio is defined as follows
$$A / W \geq 2.0 .$$

28. The fan wheel according to claim 17, wherein the height of each blade A is at least 15% of the width of each blade that air passes over (BL).

29. The fan wheel according to claim 28, wherein the height of each blade A is at least 20% of the width of each blade that air passes over (BL).

30. The fan wheel according to claim 18, wherein the shaping only extends over approximately 50% of a radial length L of the fan wheel.
